(19) United States
(12) Patent Application Publication
(10) Pub. No.: US 2014/0278995 A1
(43) Pub. Date: Sep. 18, 2014

(54) SYSTEM AND METHOD FOR CONFIGURING, SENDING, RECEIVING AND DISPLAYING CUSTOMIZED MESSAGES THROUGH CUSTOMIZED DATA CHANNELS

(71) Applicant: Xiaofan Tang, Fremont, CA (US)

(72) Inventor: Xiaofan Tang, Fremont, CA (US)

(21) Appl. No.: 14/216,435

(22) Filed: Mar. 17, 2014

Related U.S. Application Data
(60) Provisional application No. 61/792,890, filed on Mar. 15, 2013.

(51) Int. Cl. G06Q 30/02

(52) U.S. Cl. CPC G06Q 30/0257
USPC 705/14.55

(57) ABSTRACT

A system and method for receiving messages through customized data channels, users can easily setup and configure the system so that they receive only the messages that they are interested in, at the time and place that they want to receive said messages. A system and method for dynamically creating and managing customized data channels that periodically and automatically delivers customized messages to users based on their preset criteria, that requires minimum user inputs.

This application is a continuation-in-part of Application No. 61792890, filed 2013, Mar. 15.

### BACKGROUND OF THE INVENTION

1. Field of the Invention

This invention relates generally to a system and method for receiving messages through customized data channels, users can easily setup and configure the system so that they receive only the messages that they are interested in, at the time and place that they want to receive said messages. And in other aspect, this invention relates to a system for dynamically creating and managing customized data channels that periodically and automatically deliver customized messages to users based on their preset criteria, that requires minimum user inputs.

2. Description of Prior Art

It is a challenge for business owners to deliver messages regarding the products and services that they have to offer to the consumers who are interested in said messages. The current advertisement channels are used to broadcast advertisement messages to a general group of audience, without differentiating whether they are interested in receiving such advertisements. As a result, a majority of said advertisement effort is wasted. It is not a preferred situation for business owners, since most of the effort they spend for advertisement does not generate real result. For the consumers, they get so bombarded by receiving unwanted advertisements, that they have the habit of ignore the advertisements altogether. This cause the consumers to missed out on a promotional message that he/she needs, and therefore, miss the promotional package to purchase the advertised item even when that item is really what he/she needs.

This waste in advertisement is not eco-friendly. According to a report from Center for a New American Dream, the average American household receives unsolicited junk mail equal to 1.5 trees per year—more than 100 million trees for all U.S. households combined.

This invention relates to a system and method to enable a consumer to select and sign up for promotional channels that customized for his/her need, in a fast and easy way, so that he/she will only receive promotional messages that they are interested in, at the time and place that they want to receive said promotional messages.

And in another aspect, this invention relates to a system for dynamically creating and managing customized data channels that periodically and automatically deliver customized messages to users based on their preset criteria, that requires minimum user inputs.

### SUMMARY OF THE INVENTION

It is any advantage of the present invention to provide an improved system and method for receiving messages through customized data channels, users can easily setup and configure the system so that they receive only the messages that they are interested in, at the time and place that they want to receive said messages.

User can setup the system so that they will periodically and automatically receive messages through said customized data channels, with minimum user inputs.

And in another aspect, this invention relates to a system for dynamically creating and managing customized data channels that periodically and automatically deliver customized messages to said users based on their preset criteria, that requires minimum user inputs.

And in another aspect, this invention also relates to a system and method for dynamically receiving, creating, filtering, sorting, managing and sending customized messages through said customized data channels to said users.

According to another aspect of the invention, a multimedia touch screen device or system is used by vendor to display and distribute a plurality of promotional graphical images and messages to consumers. Said system used by the vendor also dynamically generates a customizable user interface that provide the means for consumer to select and enter the criteria for the promotions he or she wants to receive. Said system used by the vendor automatically generates a user interface that provides the means for user to pick up the sign up information for said promotional channel. Said promotional channel is used to periodically and continuously send a plurality of promotional messages that fits into said criteria selected and set by said consumer. Said promotional message contains data formats selected form the group consisting of text message, graphical image, audio, video, file, multimedia message and etc.

According to another aspect of the invention, another multimedia touch screen device is used by a consumer to receive said sign up information, and use it to setup consumer device and sign up for said promotion channel. Said device used by consumer continuously and periodically receives said promotional messages through the customized promotional channel, and stores the messages in the memory storage on said consumer device. Consumer can configure the settings on said consumer device, through a configuration template or user preference settings, to configure when, where and how to receive, store, process and display said promotional messages received from said customized promotional channel.

In accordance with one embodiment of the invention, when consumer receives a promotional message on said consumer device, consumer can further click on the user interface, and proceed to purchase the product that is being promoted in the message. Consumer can distribute said promotion message and/or the sign up data package of said promotional channel to other people through methods that includes but not limited to messaging, emailing, posting on website, posting to social network and etc. Consumer can further contact vendor or the providing party regarding a promotional message that may or may not be available in the system. Consumer can make review or comments for said product or promotion through the interface provided by the system.

In accordance with another embodiment of the invention, an interactive system, method and apparatus is disclosed for providing a way for vendors to communicate with consumers regarding products, services and promotions. A multimedia touch screen device owned by the consumer is used to display and distribute a plurality of promotional graphical images and messages to consumers. When consumer selects a promotional image and/or message, said device automatically generates a user interface that provides the means for user to select, configure and sign up for a customized promotional channel.

Method counterparts to these embodiments are also provided. Other embodiments, systems, methods, feature and advantage of the invention will be or will become apparent to one with skill in the art upon examination of the following figures and detailed description. It is intended that all such additional embodiments, systems, methods, features and advantages be included within the scope of the invention, and be protected by the accompanying claims.

### BRIEF DESCRIPTION OF THE DRAWINGS

FIG. 1 is a block diagram of a customized message distribution system according to one embodiment of the invention.

FIG. 2 is a schematic diagram of an exemplary message distribution system for distributing customized messages using customized data channels in accordance with an embodiment of the invention.

FIG. 3 shows an illustration of graphical promotional messages are dynamically generated and displayed in an iterative way on a graphic user interface, according to one embodiment of the invention.

FIG. 4 is a flowchart that shows sequence of process when a user browse through the promotional items, selects and enters criteria for signing up to a customized promotional channel, according to one embodiment of the invention.

FIG. 5 shows an illustration of a configuration template for a customized promotional channel to receive promotional messages for an item selected by the consumer, according to one embodiment of the invention.

FIG. 6 shows an illustration of a user scan the promotional code dynamically generated on the graphical user interface, add this data with the criteria that has been set through one of his/her configuration template, and sign up for the customized promotion channel.

FIG. 7 shows an illustration of a configuration template for a customized promotional channel to receive messages regarding weekend events, according to one embodiment of the invention.

FIG. 8 shows an illustration of a configuration template for a customized promotional channel to receive customized promotional messages, according to one embodiment of the invention.

FIG. 9 shows an illustration of a configuration template for a customized promotional channel to receive promotional messages for lunch deals, according to one embodiment of the invention.

FIG. 10 is a flowchart that shows sequence of process when a user selects and signing up for receiving promotional messages that is not yet available on the server, according to one embodiment of the invention.

### DETAILED DESCRIPTION OF THE INVENTION

An interactive system, method and apparatus are disclosed for providing a way for vendors to communicate with consumers regarding products, services and promotions. A multimedia touch screen device owned by the consumer is used to display and distribute a plurality of promotional graphical images and messages to consumers. When consumer selects a promotional image and/or message, said device automatically generates a user interface that provides the means for user to select, configure and sign up for a customized promotional channel.

In one or more embodiments of the invention, When consumers visit the store, they can view the promotion and sales messages on a touch screen graphical display and select the product or promotion message that they are interested in by clicking the image and/or message of on said touch screen display. A graphical user interface is dynamically generated, that provide the means for said consumer to select and enter the criteria for the promotions he or she wants to receive. Said vendor device then automatically generates a user interface component such an icon, a NFC data package, a bar code, a QR code and etc, that provides the means for user to pick up the sign up information for a customized promotional channel. Said user interface component are dynamically generated to contain the criteria that serves as search keys and filters for the selection of promotion messages that shall be included and communicated through said customized promotional channel.

Said promotional channel is used to periodically and continuously broadcasting a plurality of promotional messages that fits into said criteria selected and set by said consumer. Said promotional message contains a plurality of format selected from the group consisting of text message, graphical image, audio, video, file, multimedia message and etc.

Said promotional channel supported and maintained on a data server, promotional messages are group by the similarity and characteristics of the messages, and are stored in message queues on the data server, dynamically generated and periodically updated. The data server is accessible through wireless or wiring networks.

Said promotional graphical images and messages can displays on said vendor promotional system in the means of an application software program continuously running on said vendor promotional system in the foreground, continuously and dynamically generating a graphical user interface that displays said promotional graphical images and messages, as well as the user interface that provides the means for user to pick up the sign up information for a customized promotional channel.

In addition, said application software program also continuously running in the background on said vendor promotional system, communicating with the server that stores and broadcasting the promotional messages, periodically receives the updated promotional messages from said server, store said messages in the memory storage and/or disk storage on said vendor system, filter, sort, manage said messages in the memory, and continuously and dynamically update the graphical user interface with the latest and newest promotional messages in an organized way.

A multimedia touch screen device is used by a consumer to configure and sign up for a customized promotion channel. Said device used by consumer continuously and periodically receives said promotional messages through the customized promotional channel, and stores the messages in the memory storage on said consumer device. Consumer can configure the settings on said consumer device, through a configuration template or user preference settings, to configure when, where and how to receive, store, process and display said promotional messages received from said customized promotional channel.

Said device used by consumer continuously and periodically receives said promotional messages through the promotional channel, and stores the messages in the memory storage on the device used by consumer. Said consumer can select and enter user preference settings through the user interface on said consumer device. Said user preference setting is used to configure on how the promotional messages are displayed on said device, that includes but not limited to, the frequency of promotional messages being displayed on the interface, the form of promotional messages being displayed or notified to the consumer, how many times the promotional messages being displayed or notified to the consumer, how long a new promotional messages being displayed or notified to the consumer before it is categorized as old message, sorting the promotional messages based on priority predefined by said consumer, sorting and displaying the promotional messages based on priority predefined by said consumer and etc,

After said promotional messages are received on said consumer system, they are displayed or notified to the consumer based on the preference setting selected by the consumer, and stored in the memory storage and/or disk storage on said consumer device.

The means of said sign up process on the said system used by consumer can be either an automatic configuration process or a manual configuration that requires user interaction, if such is preferred by said consumer.

Consumer can configure the settings on said consumer device, through a configuration template or user preference setting, to configure when, where and how to receive, store, process and display promotional messages from said customized promotional channel. For example, consumer can select whether they want all promotional graphical images and messages that filtered through said criteria selected by them, received from said customized promotion channel to automatically show up on their mobile device as background wallpaper images, screen saver displays and/or text/graphical widget etc, or they can choose that said promotional graphical images and messages only get displayed on their mobile device once when they first become available, or chose a number of times said messages got displayed on their mobile device. Consumer can chose to unsubscribe from a promotion channel, and/or unsubscribe from a plurality of promotional channels and etc.

Said display of the promotional message can be in the means of a message popup and/or displayed in the foreground of the user interface, a push notification, or in the means of wallpaper or screen saver images automatically loading, changing and displaying on the background of the user interface on a multimedia device used by the consumer.

Old promotional messages are categorized as expired data, and are deleted from said consumer system either automatically or through a manual configuration process that requires user interaction, if such is preferred by said consumer.

The means for picking up said sign up information or signal on said consumer device can be in a form of receiving a website url, text messaging, email message that contains the data for the promotional channel, or by transferring a data package through wireless or wiring network, including scanning QR code, bar code, NFC beam and etc.

When consumer receives a promotional message on said consumer device, consumer can further click on the user interface, and proceed to purchase the product that is referred by the promotional message. Consumer can complete the purchase through interface such as mobile payment platform, or through other interface such as on the vendors mobile website.

Consumer can distribute said promotion message to other people through methods that includes but not limited to messaging, email, posting on website, posting to social network and etc.

Said consumer system also provides the means for said consumer to store the sign up information for said promotional channel in the memory storage and/or disk storage of said system, and send said sign up information to other people, or distribute to people in his/her social networks, and use different social media channels to further broadcast said promotional channel.

Consumer can make review or comments for said product or promotion by posting comments on user interface on consumer device, or website links displayed and/or linked through the promotional message, or send messages through text messaging, email, posting on social media sites and etc.

Consumer can also send messages to vendors through methods that includes but not limited to messaging, email, posting comments on website and etc.

### System Overview

Turning now to the drawings. With reference to FIG. 1, in its most basic configuration, the system used by the user 100 to received customized messages comprises at least one processing unit or processor 104 and system memory 106, a display 102, a storage unit 108 and network interface 110. In embodiments, an application program is loaded into the memory 106 of the system and executed by the system processor 104 form system memory 106, the system receives customized messages through network interface 110, store said messages in system storage 108, manage said messages using the application program in the memory 106, and display them in an iterative way on the system display 102.

Depending on the exact configuration and type of system 100, memory 106 may be volatile (such as RAM), non-volatile (such as ROM, flash memory, etc.), or some combination of the two.

An embodiment of system 100 is a wireless touch screen device, such as a smart phone, a tablet, a mobile device and other devices with similar characteristics including a smart TV.

In FIG. 2, there is illustrated an exemplary message distribution system 200 for distributing customized messages using customized data channels 214. The system 200 comprising of a user device 202 that are equipped with a display 204, a data storage 210, configuration component with the user defined configuration settings 206 and network interface 208. The user device 202 receives messages from a plurality of customized data channels 214 through the network 212. The customized data channels are supported and maintained a plurality of data servers 216. The data server 216 allocates and maintains a data message queue 218 for each of the data channel on the system memory, each data message queue 218 contains customized messages that met with the specific criteria of that customized data channels 214. Users that sign up for said customized data channel 214 receive messages that are stored in that queue 218 through said data channel 214. The message queue 218 are dynamically created, updated and maintained. Each data channel 214 have a plurality of user devices 202 sign up to it, and a user device 202 may sign up to a polarity of data channels 214. When a data channel 214 has no user sign up to it for a period of time, it will be labeled as inactive, and eventually removed from the system 200.

With reference to FIG. 3, graphical promotional messages 310 are dynamically generated and displayed in an iterative way on a graphic user interface on a touch screen device. A graphical promotional message 300 contains a graphical image of the product being promoted 302, a promotional text message 304, optional items 306 that can be selected by the user, and other user interaction item such as a dynamically generated bar code 308 as shown in the illustration. When a user selects a graphical promotion message 300, the iteration of the promotion messages 310 on said device is paused, user can select their criteria or choices for optional items 306. When the system receives the user input, it automatically creates and/or updates a user interface element, in this illustrated case, a bar code 308, which includes sign up information for the customized promotional channel based on user's selection. User can use this sign up information to sign up for said customized promotional channel.

With reference to FIG. 4, a user browses through product and promotional messages that are displayed in an iterative way, on a graphical interface displayed on a touch screen device. When the user finds a product or promotional message that he/she is interested in, he/she clicks on graphical interface, which will pause the iteration of the messages. User can then enter the criteria for the promotional messages that he/she wants to receive, the system will then dynamically generate the data package that contains the sign up information for a customized data channel. User receives said sign up data package on his/her device, and use it to complete the configuration and setup, and sign up to said customized data channel.

With reference to FIG. 5, it shows an illustration of a configuration template 500 used by a user to define when, where, what and how to receive messages through a customized promotional channel. The template 500 contains a set of parameters, user can also add, delete or edit the parameters. User can enter customized values for the parameters and use them as criteria for the customized data channel. The underlined text in the illustration is exemplary customized values that are entered and/or selected by said user. The values can be preset values, real time values, or environmental values.

With reference to FIG. 6, a user selects a promotional message 300, enters the criteria 306 for a customized promotional channel on the graphical user interface, a barcode 308 is dynamically generated by the system, that contains the sign up information for the customized promotional channel. The user scans this barcode 308 using user's device 600, and further configure it with the configuration template 500 that is configured and stored on user's device, and sign up to the customized promotional channel.

With reference to FIG. 7, it shows an illustration of a configuration template 700 used by a user to define when, where, what and how to receive messages through a customized promotional channel, to receive promotional messages related weekend activities.

With reference to FIG. 8, it shows an illustration of a configuration template 800 used by a user to define when, where, what and how to receive messages through a customized promotional channel, to receive promotional messages that has more than 40% discounts.

With reference to FIG. 9, it shows an illustration of a configuration template 900 used by a user to define when, where, what and how to receive messages through a customized promotional channel, to receive promotional messages related to restaurant lunch deals.

With reference to FIG. 10, a consumer find and select a product or promotional item he/she is interested in, he click on the item and enters criteria for receiving promotional message for that item on the graphical user interface. He/she then further sign up to said customized promotional channel. The system contacts the data server, requesting promotional messages for said customized promotional channel. When the system detects that said customized promotional channel is not yet available on the data server, it forward the request to the vendor who provides said product, said vendor reviews the criteria requested by the consumer, and decides whether to provide said promotion for said product. If said vendor approves said promotion, he/she can load the corresponding promotional message on the data server, the data server allocate said promotional message to corresponding customized promotional channel, and send it to the consumer and/or consumers. Consumer receives said promotional message on his/her device, and then proceed to purchase the item or forward the promotional message or sign up info for said promotional channel to other people.

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

What is claimed is:

1. A system for distributing customized messages to users, comprising:
a. means for organizer to display and distribute customized messages to users through customized data channels;
b. a component used by organizer that provides the means for dynamically receiving, loading, managing, sending and displaying customized messages on a multimedia device, receive user input and dynamically generating user interface and data package that provides the means for a user to sign up to a customized data channel; and
c. a component used by said user to sign up for said customized data channel, and receive customized messages through said data channel.

2. A system for distributing customized messages in accordance with claim 1, where in customized multimedia messages are received, stored, processed on said user component, iterated and displayed as background wallpaper images and/or screen saver graphical displays and/or text/graphical widgets on said user component.

3. A system for distributing customized messages in accordance with claim 1, where in said user signs up to a plurality of customized data channels, and periodically receives customized messages through said data channels on said user device.

4. A system for distributing customized messages in accordance with claim 1, where in a single-action method provides the means for said user to sign up for a selected data channel.

5. A system for distributing customized messages in accordance with claim 1, where in a two-step method provides the means for said user to customize and sign up for a customized data channel.

6. A system for distributing customized messages in accordance with claim 1, where in a plurality of configuration templates provide the means for said user to configure when, where and how to receive, store, process and display customized messages from said customized data channel.

7. A system for distributing customized messages in accordance with claim 1, further comprising claim initiating means for customizing said data channel with sets of predefined parameters, combined with the preset values and real time values of said parameters.

8. A system for distributing customized messages in accordance with claim 1, where in said promotional messages are multimedia messages that contain a plurality of elements selected from the group consisting of text, image, audio, video, file and etc.

9. A system for distributing customized messages in accordance with claim 1, further comprising claim initiating means for said organizer to generate analytical reports on data displayed, received and sent on said component used by the organizer.

10. A method for signing up to a customized promotional channel and periodically receiving messages from said channel, comprising:
a. Vendor load promotional messages to a data server;
b. Said data server stores, filters and categories said promotional messages and dynamically allocate them for a plurality promotional channels; and
c. Consumer entering the criteria's for the promotional messages that he/she wants to receive on a user interface, said user interface is dynamically generated and displayed on a component, to provide the means for said user to enter said criteria's, and used said entered criteria's as parameters to customize said promotional channel; and
d. Upon receiving said criteria on said user interface, a data package is automatically generated by said component, that contains the sign up information for a customized promotional channel; and
e. Consumer receives said data package on consumer's device, by setting up said device with said data package, said device is configured and signed up for periodically receiving promotional messages from said customized promotional channel; and
f. Promotional messages that fit into the criteria of said promotional channel are periodically transferred from data server to a plurality of consumers' devices that have signed up for said customized promotional channel.

11. A method for signing up to a customized promotional channel, in accordance with claim 10, wherein said consumer device automatically iterate through said promotional messages, and display them as background wallpaper images and/or screen saver graphical displays, and/or text/graphic widgets on said consumer device.

12. A method for signing up to a customized promotional channel, in accordance with claim 10, further comprising claim initiating means of using a plurality of configuration templates to configure when, where and how to receive, store, process and display promotional messages received from said promotional channel.

13. A method for signing up to a customized promotional channel, in accordance with claim 10, further comprising claim initiating means for said consumer to send said sign up data package to other people, with or without further customization from the consumer, that provides the means for said other people to sign up for said promotional channel.

14. A method for signing up to a customized promotional channel, in accordance with claim 10, further comprising claim initiating means for said consumer to purchase selected promotional item upon receiving said promotional message, and complete the purchase of said item on said consumer component or vendor component.

15. A method for signing up to a customized promotional channel, in accordance with claim 10, further comprising claim initiating means for said consumer to
a. enter criteria on the user interface for a promotional message that he/she wants to receive but said promotional message is not yet available in the system;
b. generate a data package that contains said criteria; and
c. send said data package to said vendor; and
d. upon receiving said data package, said vendor reviews the criteria and decide whether to provide said promotion to said consumer; and
e. said vendor can then send said promotional message directly to said consumer, or load said promotional message on the vendor component and redistribute said message through customized promotional channels, so that a plurality of consumers can receive said promotional message, and further review, update and refine said promotional message.

16. A system for consumer to receive customized promotional messages, comprising:
a. an advertisement data server to store, category and manage promotional messages;
b. means for a vendor to load promotional messages onto said data server; and
c. a component used by consumer to enter criteria and sign up for a customized promotional channel; and
d. means for said consumer component to receive promotional messages through said customized promotional channel.

17. A method for automatically configuring and setup for a customized data channel on a device, comprising:
a. a method to enter criteria for configuring a customized data channel, and dynamically generate an user interface element for said configuration data;
b. means to create or receive said element on a user device; and
c. a single-action component that in result of a single click of said user interface element by said user, provides the means to sign up said user device for said customized data channel, and automatically configure and setup said device for periodically receiving messages that fits into said criteria; and
d. a method for said user to configure the settings for said data channel, that provides the means of configuring when, where and how to receive, store, process and display data from said customized data channel.

18. A method for automatically configuring and setup for a customized data channel on a device, in accordance with claim 17, wherein said device stores said configurations made by said user, and periodically automatically repeat the process of connecting, receiving, storing, loading and displaying messages from said data channels, without requiring further action from the user.

19. A system for configuring, setup, receiving and displaying messages through a. customized promotional channel, comprising:
a. A display;
b. A memory; and
c. A network interface for communicating with a server over network; and
d. A processor, operatively coupled to the display, the memory and the network interface; and
e. An application stored in the memory and executable on the processor, for configuring and setup the system, sign up and managing the connection to a customized data channel, periodically receiving messages from said data channel, process, manage and display messages on the display, in an automatic manner that requires few or none user inputs.
